(19) United States
(12) Patent Application Publication
(10) Pub. No.: US 2025/0259348 A1
(43) Pub. Date: Aug. 14, 2025

(54) IMAGE PROCESSING APPARATUS, IMAGE PROCESSING METHOD, AND RECORDING MEDIUM

(71) Applicant: Konica Minolta, Inc., Tokyo (JP)

(72) Inventor: Tomoaki TAKEMURA, Tokyo (JP)

(21) Appl. No.: 19/046,905

(22) Filed: Feb. 6, 2025

(30) Foreign Application Priority Data
Feb. 9, 2024 (JP) 2024-018346

(51) Int. Cl. G06T 11/00; G06T 5/50; G06T 7/00

(52) U.S. Cl. CPC G06T 11/003; G06T 5/50; G06T 7/0012; G06T 2207/10124

(57) ABSTRACT

Disclosed is an image processing apparatus including: a hardware processor that: acquires a dynamic image including a plurality of frame images by performing dynamic imaging on a target site of a subject by a radiation imaging apparatus; acquires a functional information image including volume data including a plurality of voxels by imaging the target site by another different modality; acquires anatomical information or lesion information regarding the target site of the functional information image; generates a DRR image based on the functional information image and the anatomical information or the lesion information; integrates a plurality of frames of the dynamic image and the DRR image to obtain an integrated image; and outputs the integrated image. The hardware processor adds, to the DRR image, depth information indicating a distance from a reference position of the anatomical information or the lesion information in the volume data.

### CROSS-REFERENCE TO RELATED APPLICATIONS

The present invention claims priority under 35 U.S.C. § 119 to Japanese Patent Application No. 2024-018346 filed on Feb. 9, 2024, the entire contents of which being incorporated herein by reference.

### BACKGROUND OF THE INVENTION

### Technical Field

The present invention relates to an image processing apparatus, an image processing method, and a recording medium.

### Description of Related Art

A dynamic image of a target site of a subject is acquired by dynamic imaging in which the target site of the subject is continuously irradiated with pulsed X-rays by a radiation imaging apparatus. According to the dynamic image, for example, it is possible to observe the movement of the lung field, a change in luminance on the image, and the like accompanied by breathing and heartbeats. On the other hand, it is difficult to observe anatomical information of a lung field such as a bronchus, a blood vessel, and a lung lobe in a dynamic image.

In recent years, in lung resection surgery, it has been studied to predict the degree of difficulty, surgery time, and the like of lung resection surgery in advance by estimating the presence and size of pleurodesis using dynamic imaging. However, since the dynamic imaging cannot capture the lobular failure of the lung and cannot sufficiently secure information necessary for the lung resection surgery, it has been difficult to accurately predict the degree of difficulty and the like of the lung resection surgery. A CT apparatus, an MRI apparatus, and the like can depict anatomical information on lung lobes, bronchus, blood vessels, and the like. Therefore, it is necessary to individually check the dynamic image captured by the radiation imaging apparatus and the analysis result of the image acquired by the CT apparatus at the time of the current lung resection planning.

An image processing apparatus for simultaneously confirming a dynamic image captured by a radiation imaging apparatus and an image acquired by another modality is proposed in Japanese Unexamined Patent Publication No. 2018-183493. The image processing apparatus integrates the lung field region of the dynamic image captured by the radiation imaging apparatus and the lung field region of the functional information image acquired by the SPECT apparatus and displays the integrated image on the display part.

### SUMMARY OF THE INVENTION

With conventional technologies, it is possible to superimpose a DRR image generated from a CT apparatus on a dynamic image. However, the conventional image processing apparatus has a problem that it is not possible to superimpose, on each frame of a dynamic image, anatomical information such as the lobes of a target site and further the depth of the anatomical information.

Therefore, in order to solve the above-described problem, an object of the present invention is to provide an image processing apparatus, an image processing method, and a recording medium capable of superimposing anatomical information or the like on a dynamic image, the anatomical information being on a target site such as a lobe of a lung.

To achieve at least one of the abovementioned objects, according to an aspect of the present invention, an image processing apparatus reflecting one aspect of the present invention comprises:
a hardware processor that:
acquires a dynamic image including a plurality of frame images by performing dynamic imaging on a target site of a subject by a radiation imaging apparatus;
   acquires a functional information image including volume data including a plurality of voxels by imaging the target site by another modality different from the radiation imaging apparatus;
   acquires anatomical information or lesion information regarding the target site of the functional information image;
   generates a DRR image based on the acquired functional information image and the anatomical information or the lesion information that is acquired;
   integrates a plurality of frames of the acquired dynamic image and the generated DRR image to obtain an integrated image; and
   outputs the integrated image, wherein
   the hardware processor adds, to the DRR image, depth information indicating a distance from a reference position of the anatomical information or the lesion information in the volume data.

To achieve at least one of the abovementioned objects, according to another aspect of the present invention, an image processing method reflecting one aspect of the present invention comprises:
first acquiring that is acquiring a dynamic image including a plurality of frame images by performing dynamic imaging on a target site of a subject by a radiation imaging apparatus;
   second acquiring that is acquiring a functional information image including volume data including a plurality of voxels by imaging the target site by another modality different from the radiation imaging apparatus;
   third acquiring that is acquiring anatomical information or lesion information regarding the target site of the functional information image;
   generating that is generating a DRR image based on the acquired functional information image and the anatomical information or the lesion information that is acquired;
   integrating that is integrating a plurality of frames of the acquired dynamic image and the generated DRR image to obtain an integrated image; and
   outputting that is outputting the integrated image, wherein
   in the generating, depth information indicating a distance from a reference position of the anatomical information or the lesion information in the volume data is added to the DRR image.

To achieve at least one of the abovementioned objects, according to another aspect of the present invention, a recording medium reflecting one aspect of the present invention is a non-transitory recording medium storing a computer-readable program causing a computer to execute:
first acquiring that is acquiring a dynamic image including a plurality of frame images by performing dynamic imaging on a target site of a subject by a radiation imaging apparatus;
   second acquiring that is acquiring a functional information image including volume data including a plurality of voxels by imaging the target site by another modality different from the radiation imaging apparatus;
   third acquiring that is acquiring anatomical information or lesion information regarding the target site of the functional information image;
   generating that is generating a DRR image based on the acquired functional information image and the anatomical information or the lesion information that is acquired;
   integrating that is integrating a plurality of frames of the acquired dynamic image and the generated DRR image to obtain an integrated image; and
   outputting that is outputting the integrated image, wherein
   in the generating, depth information indicating a distance from a reference position of the anatomical information or the lesion information in the volume data is added to the DRR image.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a diagram showing an example of the configuration of the image display system according to the present embodiment;

FIG. 2 is a diagram illustrating an example of a block diagram of the analysis apparatus according to the present embodiment;

FIG. 3 is a flowchart illustrating an example of the operation of the analysis apparatus when executing analysis processing for combining a dynamic image and a DRR image according to the present embodiment;

FIG. 4 is a diagram showing an example of a configuration of volume data reconstructed by a coronal section according to the present embodiment;

FIG. 5 is a diagram illustrating an example of a configuration of a coronal section of the tenth slice of the volume data according to the present embodiment;

FIG. 6 is a diagram illustrating a conceptual diagram in a case of generating a two dimensional first DRR image and the like from a CT image by a ray casting algorithm according to the present embodiment;

FIG. 7 is a diagram showing an example of the configuration of the first DRR image according to the present embodiment;

FIG. 8 is a diagram showing an example of the configuration of the second DRR image according to the present embodiment;

FIG. 9A is a diagram showing depth information of a boundary of a lobe of a lung viewed from the y direction according to the present embodiment;

FIG. 9B is a diagram illustrating depth information of a boundary between lobes of a lung as viewed from the z direction according to the present embodiment;

FIG. 10 is a diagram illustrating an example of the configuration of the second DRR image in which each boundary of the lobes of the lung is color-coded according to the distance according to the present embodiment;

FIG. 11 is a diagram illustrating an example of the configuration of a third DRR image according to the present embodiment;

FIG. 12 is a diagram illustrating an example of a configuration of an integrated image according to the present embodiment;

FIG. 13 is a diagram illustrating another display example 1 of the third DRR image in a case where only the boundary between the right upper lobe and the right middle lobe is visualized;

FIG. 14 is a diagram illustrating another display example 2 of the third DRR image in a case where only the boundary between the right middle lobe and the right lower lobe is visualized;

FIG. 15 is a diagram illustrating another display example 3 of the third DRR image when only the boundary between the left upper lobe and the left lower lobe is visualized;

FIG. 16 is a diagram illustrating another display example 4 of the third DRR image in a case where the boundary between the right upper lobe and the right middle lobe, the boundary between the right middle lobe and the right lower lobe, and the boundary between the left upper lobe and the left lower lobe in the middle six cross sections among the sixteen coronal sections are visualized;

FIG. 17 is a diagram illustrating another display example 5 of the third DRR image in a case where only the boundary between the right upper lobe and the right middle lobe in six middle cross sections among sixteen coronal sections is visualized;

FIG. 18 is a diagram illustrating another display example 6 of the third DRR image in a case where only the boundaries between the right middle lobe and the right lower lobe in six middle cross sections among the 16 coronal sections are visualized; and

FIG. 19 is a diagram illustrating another display example 7 of the third DRR image in a case where only the boundaries between the left upper lobe and the left lower lobe in the six middle cross sections among the sixteen coronal sections are visualized.

### DETAILED DESCRIPTION

In the following, a preferred embodiment of the present disclosure will be described in detail with reference to the accompanying drawings. However, the scope of the invention is not limited to the disclosed embodiments.

### Example of Configuration of Image Processing System 100

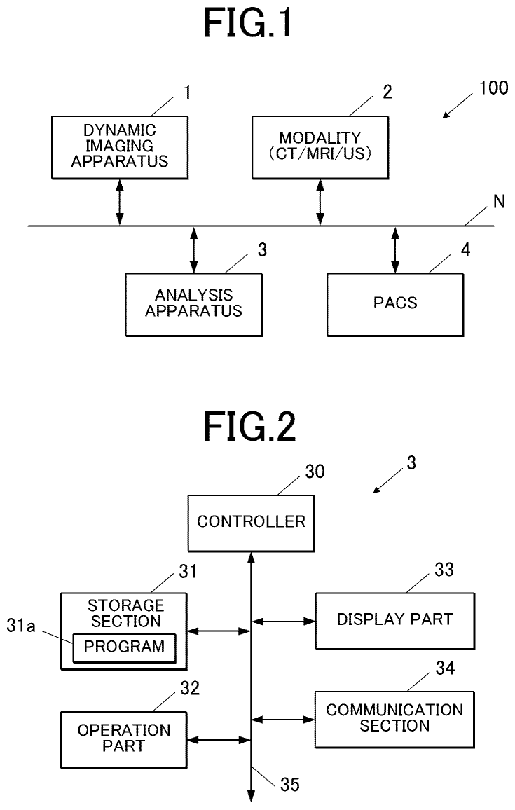

FIG. 1 illustrates an example of a configuration of an image processing system 100 according to the present embodiment. The image processing system 100 includes a dynamic imaging apparatus 1, a modality 2, an analysis apparatus 3, and a PACS4. The dynamic imaging apparatus 1, the modality 2, the analysis apparatus 3, and the PACS4 are communicably connected to each other via a network N. Examples of the network N include a LAN, a WAN, the Internet, and the like. LAN is an abbreviation for Local Area Network. WAN is an abbreviation for Wide Area Network.

The dynamic imaging apparatus 1 is an example of a radiation imaging apparatus, and includes, for example, a radiation source, an exposure switch, and an X-ray detector. The dynamic imaging apparatus 1 performs dynamic imaging by irradiating an imaging part of a subject with X-rays from a radiation source in response to pressing of an exposure switch. The X-ray detector is, for example, a flat panel detector (FPD) and detects X-rays or the like that have passed through the subject. The dynamic imaging apparatus 1 generates a dynamic image of the lungs and the like of the subject based on the output from the X-ray detector.

In the present embodiment, dynamic imaging refers to acquiring a series of images of a subject by repeatedly irradiating the subject with pulsed radiation such as X-rays at predetermined time intervals in accordance with one imaging operation. Repeatedly applying radiation in a pulsed manner at predetermined time intervals is referred to as pulsed irradiation. Alternatively, dynamic imaging refers to acquiring a series of images of a subject by continuously irradiating the subject at a low dose rate in accordance with one imaging operation. Continuous irradiation with radiation without interruption is referred to as continuous irradiation. A series of images obtained by dynamic imaging is called a dynamic image. Furthermore, each of all the images forming the dynamic image is referred to as a frame image. Here, the dynamic imaging includes moving image capturing but does not include capturing a still image while displaying a moving image. Furthermore, the dynamic image includes a moving image but does not include an image obtained by capturing a still image while displaying the moving image.

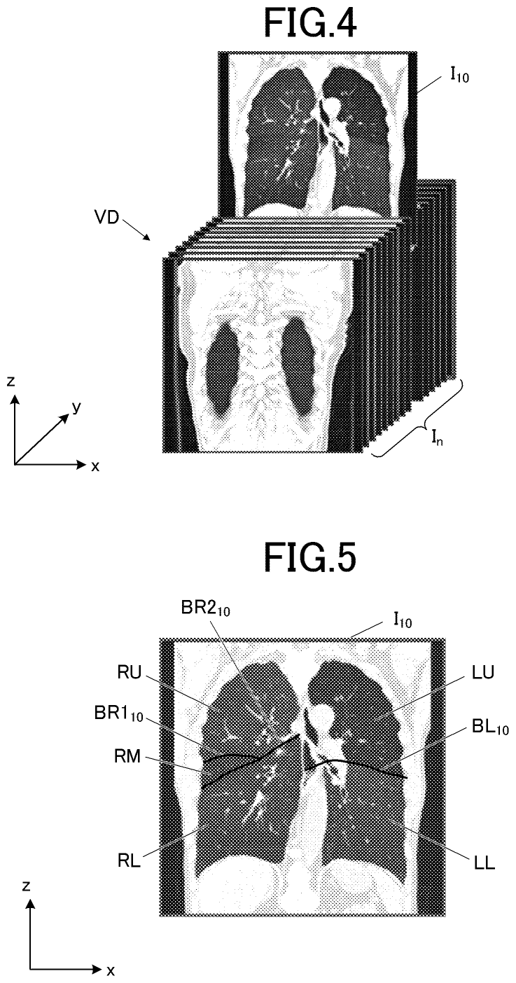

The modality 2 is, for example, a CT apparatus, an MRI apparatus, an ultrasonic diagnostic apparatus, or the like. In the present embodiment, a case in which a CT apparatus is used as the modality 2 will be described, and the modality 2 will be referred to as the CT apparatus 2. The CT apparatus 2 irradiates a subject with X-rays from an X-ray tube and detects the irradiated X-rays with an X-ray detector. The CT apparatus 2 generates a CT image of the imaging region of the subject based on the output from the X-ray detector. The CT image is an example of a functional information image and is composed of, for example, volume data VD (see FIG. 4). The volume data VD is three dimensional shape data and includes a plurality of voxels obtained by dividing the inside of a rectangle into a plurality of unit regions in a grid pattern.

The analysis apparatus 3 is an example of an image processing apparatus and acquires a dynamic image of an imaging part of a subject captured by dynamic imaging by the dynamic imaging apparatus 1 and a CT image of the imaging part of the subject captured by the CT apparatus 2. The dynamic image and the CT image may be acquired from PACS4. The analysis apparatus 3 acquires the anatomical information of the imaging site and the depth information of the lesion information from the CT image and adds the acquired depth information to a DRR image based on the CT image. The analysis apparatus 3 integrates the DRR image into each frame image of the dynamic image, and outputs the integrated image to PACS4 or the like. The DRR is an abbreviation for Digitally Reconstructed Radiograph.

A PACS (Picture Archiving and Communication System) 4 is a medical image management system. The PACS4 stores and manages the dynamic image captured by the dynamic imaging apparatus 1, the CT image captured by the CT scanner 2, the integrated image on which predetermined processing has been performed by the analysis apparatus 3, and the like. The PACS4 displays the above-described dynamic image, CT image, integrated image, and the like on a display part and outputs them to information terminals, viewers, and the like based on an instruction from a user such as a doctor or radiologist.

### Example of Configuration of Analysis Apparatus 3

Next, a configuration of the analysis apparatus 3 according to the present embodiment will be described. FIG. 2 illustrates an example of a block diagram of the analysis apparatus 3 according to the present embodiment.

The analysis apparatus 3 includes a controller 30 (hardware processor), a storage section 31, an operation part 32, a display part 33, and a communication section 34. The controller 30, the storage section 31, the operation part 32, the display part 33, and the communication section 34 are connected to each other via wiring such as a bus 35.

The controller 30 includes, for example, a processor such as a CPU that performs calculation and control, a memory, and the like. CPU is an abbreviation for Central Processing Unit. The controller 30 executes, for example, a program 31a (to be described later) stored in a memory such as a RAM, the storage section 31, or the like, to thereby implement processing of adding depth information or the like of anatomical information of a CT image to a DRR image of the CT image, or the like. The controller 30 may include an electronic circuit such as an ASIC or an FPGA. ASIC is an abbreviation of Application Specific Integrated Circuit. FPGA is an abbreviation for Field Programmable Gate Array.

In the present embodiment, the controller 30 functions as a first acquisition section, a second acquisition section, a third acquisition section, a generation section, an integration section, and an output section. The processor or the like of the controller 30 realizes the functions of a first acquisition section, a second acquisition section, a third acquisition section, a generation section, an integration section, an output section, and the like by executing the program stored in the storage section 31 or the like.

The first acquisition section acquires a dynamic image including a plurality of frame images by performing dynamic imaging on an imaging part of a subject by the dynamic imaging apparatus 1. The second acquisition section acquires a CT image including volume data VD (see FIG. 4) composed of a plurality of voxels by imaging the imaging site with another CT apparatus 2 different from the dynamic imaging apparatus 1. The third acquisition section acquires anatomical information or lesion information on an imaging part of the CT image. Examples of the anatomical information include lobes of the lungs, blood vessels, and bronchus. Examples of the lesion information include a nodule, a tumor, stenosis of a blood vessel, calcification, and an aortic aneurysm.

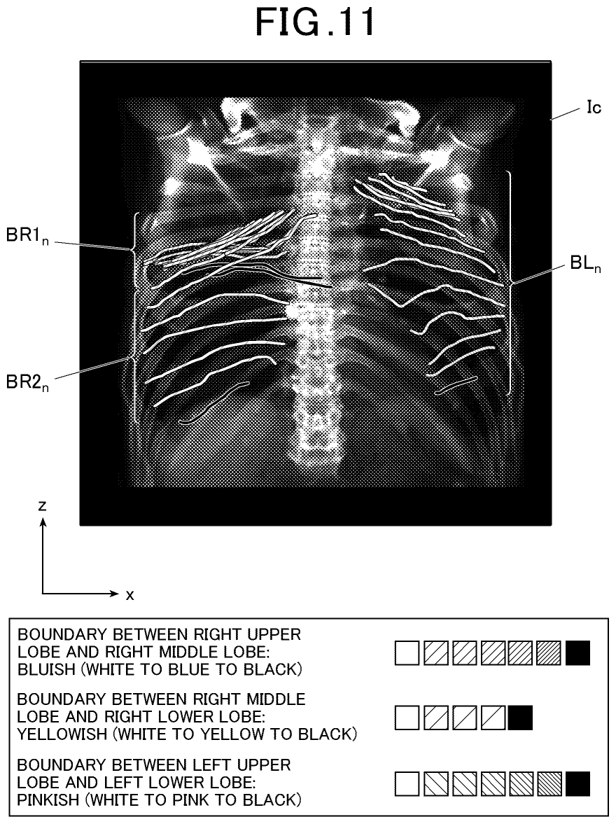

The generation section generates a third DRR image (see FIG. 11) on the basis of the CT image acquired by the second acquisition section and the anatomical information or the lesion information acquired by the third acquisition section. In this case, the generation section adds depth information indicating a distance from a reference position of the anatomical information or the lesion information in the volume data VD to the DRR image. The integration section integrates the plurality of frames of the dynamic image acquired by the first acquisition section and the third DRR image generated by the generation section. The output section outputs the integrated image integrated by the integration section to the display part 33 or the like.

The storage section 31 includes any storage module such as an HDD, an SSD, a ROM, and a RAM, for example. HDD is an abbreviation of Hard Disk Drive. SSD is an abbreviation for Solid State Drive. ROM is an abbreviation of Read Only Memory. The storage section 31 stores, for example, a system program, an application program, and various types of data. To be specific, the storage section 31 stores a program 31a for executing a process of adding the depth information or the like of the anatomical information of the CT image to the DRR image of the CT image.

The operation part 32 includes, for example, a mouse, a keyboard, a switch, and a button. The operation part 32 may be, for example, a touch screen integrally combined with a display or may be an interface that receives voice input. The operation part 32 receives an instruction corresponding to various input operations from a user, converts the received instruction into an operation signal, and outputs the operation signal to the controller 30. Specifically, the operation part 32 receives an instruction such as selection of a dynamic image and a DRR image used when the DRR image is combined with the dynamic image.

The display part 33 is, for example, a display such as a liquid crystal display or an organic EL display. The EL is an abbreviation for Electro Luminescence. The display part 33 displays an image on which predetermined analysis processing has been performed, a GUI for receiving various input operations from a user, and the like. GUI is an abbreviation for Graphical User Interface. Specifically, the display part 33 displays a combined image or the like in which the DRR image to which the depth information or the like of the anatomical information of the CT image is added is combined with each frame image of the dynamic image.

The communication section 34 includes, for example, a communication module including an NIC, a receiver, and a transmitter. NIC is an abbreviation for Network Interface Card. The communication section 34 communicates various kinds of information and images with the dynamic imaging apparatus 1, the modality 2, and the PACS4 via the network N.

### Operation Example of Analysis Apparatus 3

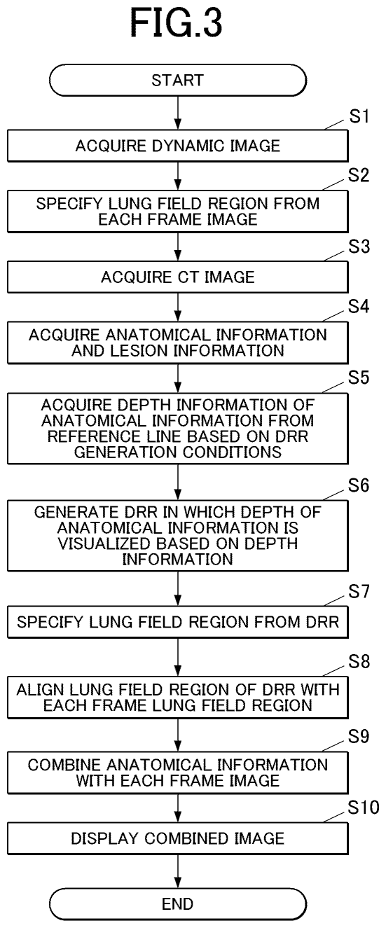

Next, a flow in a case where the analysis method according to the present embodiment is executed will be described. FIG. 3 is a flowchart showing an example of the operation of the analysis apparatus 3 in the case of executing analysis processing for combining a dynamic image and a DRR image according to the present embodiment. Hereinafter, a case where the imaging region is a lung will be described.

The controller 30 acquires a dynamic image including a plurality of frames of the lungs to be processed (step S1). The step S1 corresponds to a first acquisition step. For example, the controller 30 may display an image search screen or the like on the display part 33 and acquire a predetermined dynamic image from the image search screen or the like by an input operation of the operation part 32. The dynamic image may be acquired from the storage section 31 PACS4.

The controller 30 specifies a lung field region from each frame image of the acquired dynamic image (step S2). The method for specifying the lung field region is not particularly limited, and a known method can be applied. For example, the specifying method disclosed in Japanese Patent No. 2-987633 can be applied. Specifically, the lung field region is specified by utilizing the fact that the image densities of the right and left lung parts of the lung field region are higher than those of the peripheries in the X-ray image. The controller 30 creates a density histogram of an arbitrary frame image. Next, the controller 30 determines an image portion of the high-density region corresponding to the lung field region from the shape and area size of the created density histogram and specifies the image portion as the lung field. As others, a specific method disclosed in Japanese Unexamined Patent Publication No. 2003-6661 can be applied. Specifically, the controller 30 specifies the lung field region by performing template matching on an arbitrary frame image using a template that defines the outline of a standard lung field region.

The controller 30 acquires a CT image including the volume data VD of the lungs to be processed (step S3). Step S2 corresponds to a second acquisition step. For example, the controller 30 may display an image search screen or the like on the display part 33 and acquire a predetermined CT image from the image search screen or the like by an input operation of the operation part 32. The CT image may be acquired from the storage section 31 PACS4. The controller 30 generates a plurality of coronal (coronal) cross sections Iₙ from the volume data VD of the acquired CT image. As a reconstruction method, a known technique can be applied.

FIG. 4 shows an example of the configuration of volume data VD reconstructed by a coronal section Iₙ (n is an integer) according to the present embodiment. In the following drawings, planar directions of the coronal section Iₙ are defined as an x direction and a z direction. In addition, a direction which is orthogonal to the x direction and the z direction and in which the coronal sections Iₙ are laminated is defined as a y direction. A near side in a y direction of the volume data VD is defined as an abdominal side (A side) of the patient, and a far side in the y direction is defined as a back side (P side) of the patient. In the present embodiment, the coronal sections Iₙ reconstructed from the volume data VD are composed of 160 pieces. Further, the 160 coronal sections I are divided into 16 sections, and one coronal section at the head of the 10 coronal sections in each divided section is treated as a representative of the section. Therefore, the volume data VD in FIG. 4 is constituted by coronal sections of n=1, 11, 21, 31, 41, 51, 61, 71, 81, 91, 101, 111, 121, 131, 141, and 151. Further, instead of using one coronal section out of the ten coronal sections in each divided section as a representative, a coronal section obtained by overlapping ten coronal sections and calculating an average of the ten coronal sections for each pixel may be used as a representative. The volume data VD includes voxels of a lung, or the like divided into five lobes.

The controller 30 acquires boundaries between lobes of the lungs as anatomical information from the volume data VD of the acquired CT image of the lungs (step S4). Step S4 corresponds to a third acquisition step. As a method of acquiring the boundaries of the lobes of the lungs, for example, a technique disclosed in Japanese Unexamined Patent Publication No. 2008-142481 can be applied. The controller 30 enhances the interlobar fissure running between the lung lobes of the lung from the voxel of the volume data VD, which is the CT image, and extracts the enhanced lobar fissure from the CT image. Next, the controller 30 divides the lung into units of lobes with the extracted interlobar fissures as boundaries. FIG. 5 is a view showing an example of the configuration of a tenth coronal section I₁₀ in the volume data VD according to the present embodiment. The right lung is divided into three lobes, i.e., a right upper lobe RU, a right middle lobe RM, and a right lower lobe RL by the boundaries BR1ₙ and BR2ₙ. The left lung is divided into two lobes, a left upper lobe LU and a left lower lobe LL, by a boundary BL n. The controller 30 acquires the boundary BR1ₙ and the boundary BR2n as the anatomical information of the right lung and acquires the boundary BLₙ as the anatomical information of the left lung. Note that the divided lung lobes may be further divided into units of lung segments.

Furthermore, in a case of acquiring blood vessels as the anatomical information, the technology described in “Yamamoto h,et al. Technical Report of IEICE,JAMITpp. 169˜pp. 175 (2005)” may be applied.

The case of acquiring bronchus as anatomical information is described in “Study on Extraction of Bronchi from Thoracic Computed Tomography (CT) Image by Machine Learning and Graph Cut, The Institute of Electronics, Information and Communication Engineers of Japan, IEICE Techniques MI2012-98 (2013-01)”.

The present technology may be applied.

In a case of acquiring a nodule or a tumor as the lesion information, a technique described in the following literature may be applied. The document is “Detection of Image Finding of Pulmonary Nodule in Chest CT Image and Distinction between Benign and Malignant using Deep Learning, MEDICAL IMAGING TECHNOLOGY Vol.37 No.5 November 2019”. In a case where stenosis of a blood vessel or an aortic aneurysm is acquired as the lesion information, a method of determining stenosis or aneurysm using a blood vessel diameter in a cross section orthogonal to the center line of the extracted blood vessel may be applied. When calcification is acquired as the lesion information, a calcification determination method based on a CT value in a blood vessel region may be applied.

The controller 30 generates the first DRR image Ia of the volume data VD based on the DRR generation conditions and acquires the depth information at the boundary between the lobes of the lungs acquired (step S5). First, the controller 30 generates the first DRR image Ia of the volume data VD of the CT image, based on the DRR generation conditions. Step S5 corresponds to a generating step. The DRR generation condition includes, for example, the position of the X-ray source in the coordinate space of the volume data VD, the six axis rotation condition of the volume data VD, the adjustment of the X-ray absorption/scattering modeling, and the DRR image.

Contrast adjustment and the like can be mentioned.

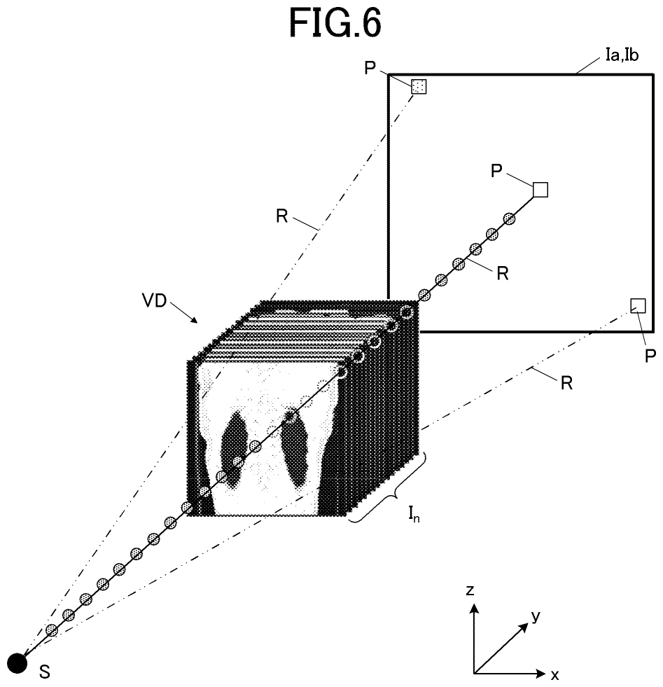

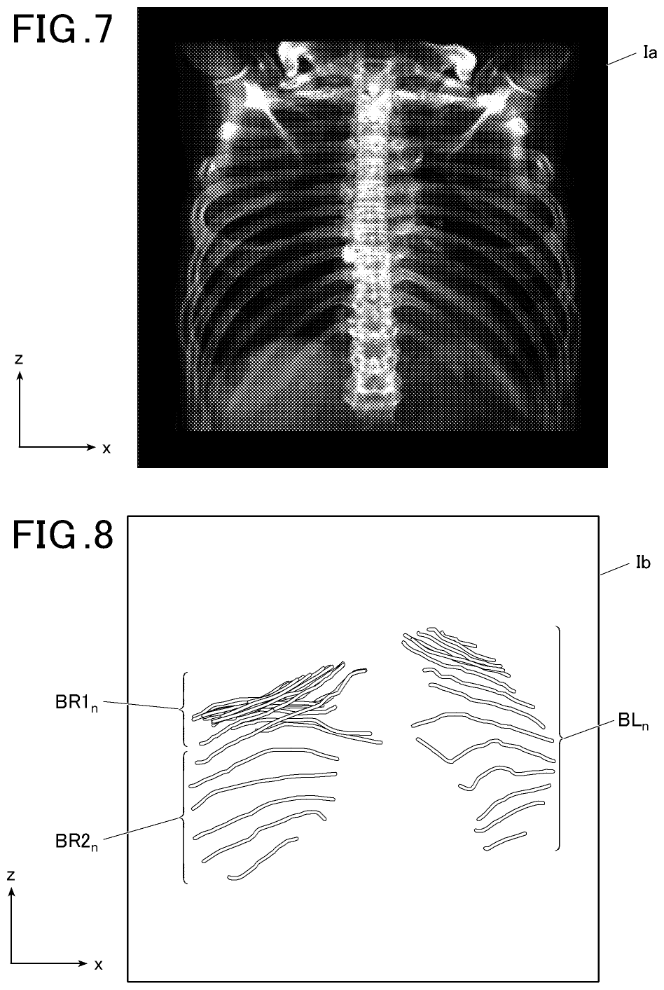

FIG. 6 shows a conceptual diagram in the case of generating the two dimensional first DRR image Ia and the like from the CT image by the ray casting algorithm according to the present embodiment. FIG. 7 is a diagram showing an example of the configuration of the first DRR image Ia. The controller 30 generates the DRR image to be processed, for example, by executing a ray casting algorithm. When the start point is replaced with the X-ray source S in ray casting, radial rays R passing through the X-ray source S and the volume data VD are assumed. The controller 30 generates the first DRR image Ia by summing (integrating) the luminance values of the voxels at the sampling points on the assumed rays R and reflecting the finally reached summed luminance value in the pixel value P.

Next, the controller 30 generates a second DRR image Ib in which each boundary of the lobe of the lung in each coronal section Iₙ is two dimensionally visualized from the volume data VD by a ray casting algorithm. Specifically, the controller 30 detects voxels located at the boundaries of the lobes of the lung on the ray R from the X-ray source S in each coronal section Iₙ of the volume data VD, based on the anatomical information indicating the boundaries of the lobes acquired in step S4. FIG. 8 is a diagram showing an example of the configuration of the second DRR image Ib according to the present embodiment. In the second DRR image Ib, a voxel of a boundary BLₙ between the left upper lobe LU and the left lower lobe LL of the left lung in each coronal section Iₙ is represented as a pixel value. In addition, in the second DRR image Ib, a voxel at the boundary BR1ₙ between the right upper lobe RU and the right middle lobe RM of the right lung and a voxel at the boundary BR2n between the right middle lobe RM and the right lower lobe RL of the right lung in each coronal section In are expressed as pixel values. At this stage, no depth information is added to the second DRR image Ib.

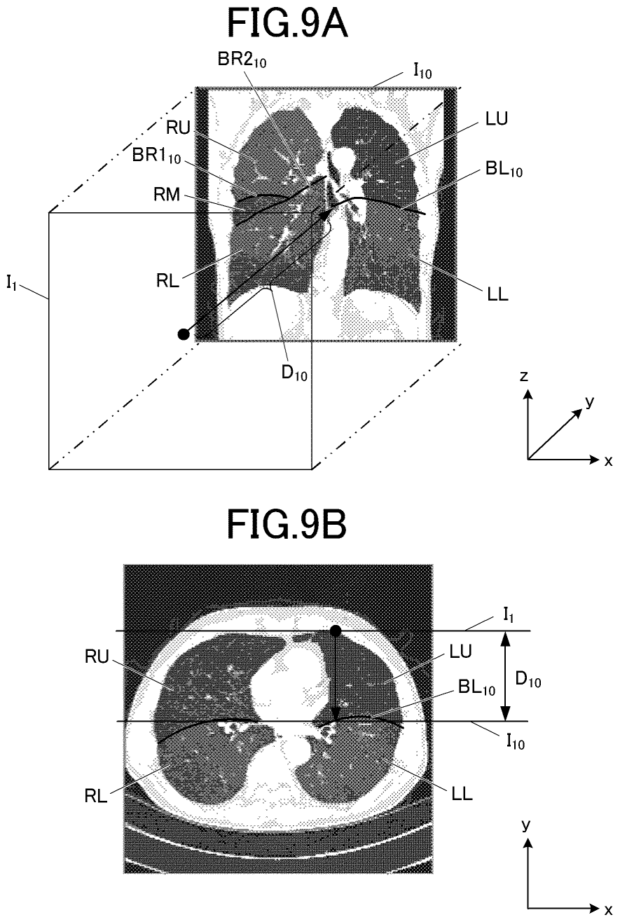

The controller 30 calculates distances Dₙ to the coronal sections Iₙ including the voxels at the boundaries of the lobes of the lungs with reference to the coronal section I₁ which is the lung field region position closest to the X-ray source in the coronal section Iₙ. Hereinafter, the reference coronal section I₁ is referred to as a reference coronal section I₁. In addition, as an example, a case where the length D₁₀ between the reference coronal section I₁ and the tenth coronal section I₁₀ is calculated will be described. FIG. 9A is a diagram illustrating depth information of a boundary between lobes of a lung as viewed from a y direction, and FIG. 9B is a diagram illustrating depth information of a boundary between lobes of a lung as viewed from a z direction. As shown in FIG. 9A and FIG. 9B, the controller 30 calculates distances D₁₀ in the y direction between the reference coronal section I₁ and the tenth coronal section I₁₀. As a means for calculating the distance D, for example, the number of images of the coronal sections Iₙ may be used, or a distance obtained by multiplying the number of images by the slice thickness (mm/image) of the coronal sections In may be used. The reference coronal section Iₙ is not limited to the coronal section I₁, and may be another coronal section Iₙ or the like.

Next, the controller 30 generates a second DRR image Ib in which the boundaries of the lobes of the lungs in each coronal section Iₙ are visualized based on the distances Dₙ which are the calculated depth information (step S6). To be specific, the controller 30 normalizes each of the distances Dₙ between each of the acquired coronal sections Iₙ and the reference coronal section I₁. For example, the controller 30 scales each of the distances Dₙ between each of the acquired coronal sections Iₙ and the reference coronal section I₁ between the minimum “0” and the maximum “1”. The controller 30 acquires a value Dₙₙ normalized for each range Dₙ of each coronal section Iₙ by scaling.

In the present embodiment, the minimum “0” and the maximum “1” in the normalized value Dₙₙ are set to white and black, respectively, and the depth of the boundary between the lobes of the lungs in each coronal section Iₙ is visualized by color shading. For example, the controller 30 obtains the color of each coronal section Iₙ in the boundary BR1ₙ for each range Dₙ based on the boundary color (R_{BR1}, G_{BR1}, B_{BR1}) representing the boundary BR1ₙ between the right upper lobe RU and the right middle lobe RM of the right lung set in advance and the value Dₙₙ normalized for each range Dₙ of each coronal section Iₙ. In particular, the color of each coronal section Iₙ at the boundary BR1ₙ for each of the distances Dn can be obtained using the following expression.

(R_{BR1}, G_{BR1}, B_{BR1})=(R_{BR1}×(1−Dₙₙ), G_{BR1}×(1−Dₙₙ), B_{BR1}×(1−Dₙ)).

Similarly, at the boundary BR2ₙ between the right middle lobe RM and the right lower lobe RL of the right lung, the color of each coronal section Iₙ at the boundary BR2ₙ for each of the distances Dₙ can be obtained based on the boundary color (R_{BR2}, G_{BR2}, B_{BR2}) representing the boundary BR2ₙ set in advance and the value Dₙₙ normalized for each of the distances Dₙ of each coronal section Iₙ. At the boundary BLₙ between the left upper lobe LU and the left lower lobe LL of the left lung, based on the boundary color (R_{BL}, G_{BL}, B_{BL}) representing the boundary BLₙ set in advance and the value Dₙₙ normalized for each of the distances Dₙ of each coronal section Iₙ, the color of each of the distances Dₙ of each coronal section Iₙ at the boundary BLₙ can be obtained. In this way, the boundaries of the lobes of the lungs in the second DRR image Ib can be color-coded according to the distances Dₙ of the coronal sections Iₙ.

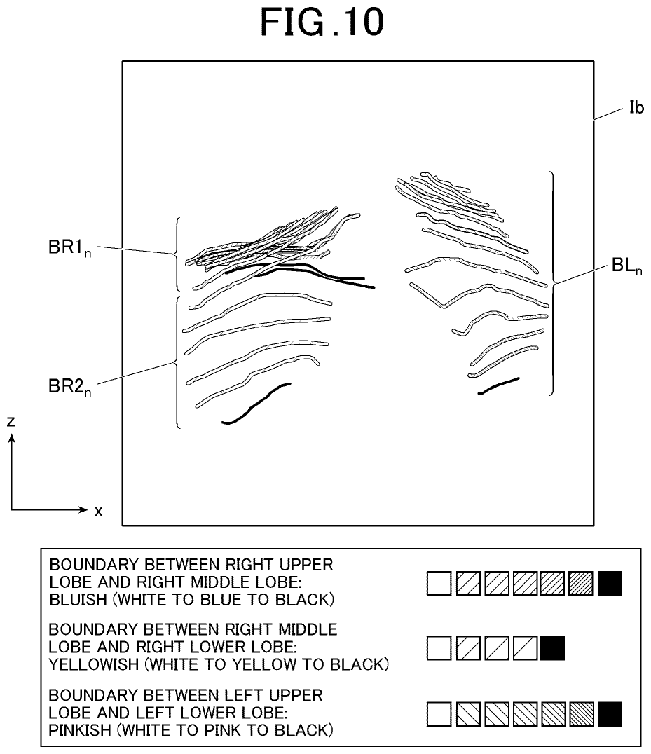

FIG. 10 is a diagram showing an example of a configuration of the second DRR image Ib in which the boundaries of the lobes of the lungs are color-coded according to the distances Dₙ according to the present embodiment. For example, the boundary BR1ₙ between the right upper lobe RU and the right middle lobe RM of the right lung is set to the bluish and is expressed in the range of white to blue to black in accordance with the normalized value Dₙₙ. The boundary BR2ₙ between the right middle lobe RM and the right lower lobe RL is set to be yellowish and is expressed in a range of white to yellow to black according to the normalized value Dₙₙ. The boundary BLₙ between the left upper lobe LU and the left lower lobe LL of the left lung is set to be pinkish and is expressed in a range of white to pink to black according to the normalized value Dₙₙ. In the present embodiment, the ventral side (A side) of the patient is expressed with a lighter color, and the dorsal side (P side) of the patient is expressed with a darker color. Furthermore, in FIG. 10 and the like below, the boundary of the divided lobe of the right lung and the boundary of the divided lobe of the left lung are classified by the direction of hashing, and the distance Dₙ of the boundary of the divided lobe is expressed by the interval of hatching. The narrower the interval of the hatching is, the further the position is located on the back side of the patient.

Note that the depth of the boundary between the lobes of the lungs in each coronal section Iₙ may be expressed only by shading. As a result, the boundaries of the lobes of the lungs in the second DRR image Ib can be expressed by shading according to the distances Dₙ of the coronal sections Iₙ. In the above-described example, the color and the shade are changed for each distance Dₙ of each coronal section Iₙ, but the present invention is not limited thereto. For example, the depth direction (AP direction) of the volume data VD may be divided into a plurality of sections, and the color and gray level may be changed in each section.

The controller 30 generates the third DRR image Ic by superimposing the generated second DRR image Ib illustrated in FIG. 8 on the generated first DRR image Ia illustrated in FIG. 7. FIG. 11 shows an example of the configuration of the third DRR image Ic according to the present embodiment. According to the third DRR image Ic, the depth direction of the boundary between the lobes of the lungs in each coronal section Iₙ can be expressed two dimensionally.

The controller 30 specifies a lung region from the third DRR image Ic (step S7). For example, the controller 30 may binarize the third DRR image Ic with a predetermined threshold and specify, as the lung field region, a region whose binarized value is equal to or more than the threshold. Alternatively, the lung field region may be specified from the third DRR image Ic by using another known method. Note that the lung field region may be specified from the first DRR image Ia at a timing before the second DRR image Ib is superimposed on the first DRR image Ia.

The controller 30 aligns the lung field region specified from the third DRR image Ic or the like with the lung field region of each frame of the dynamic image (step S8). For example, the controller 30 non-rigidly aligns the lung field region in the third DRR image Ic or the like with the lung field region in each frame of the dynamic image, on the basis of the landmarks such as the lung field, the lung apex, and the lung base.

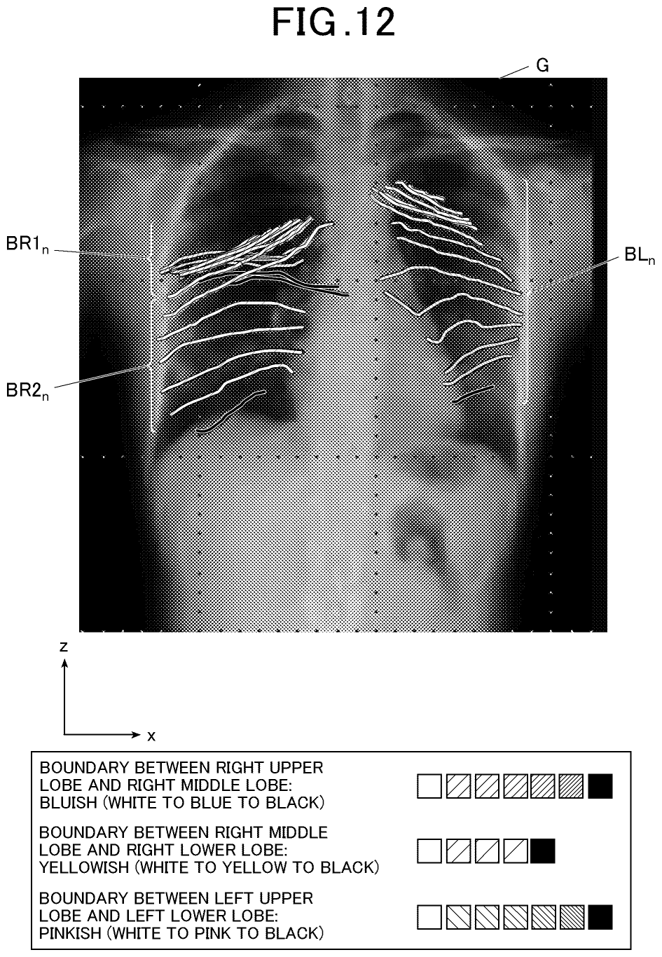

The controller 30 aligns the lung field region in the third DRR image Ic or the like with each frame of the dynamic image, and then integrates (combines) each boundary of the lobes of the lungs in the second DRR image Ib with each frame image of the dynamic image to generate an integrated image G (step S9). Step S9 corresponds to an integration step. For example, the controller 30 performs alpha blending for each corresponding pixel of each frame image and the third DRR image Ic to generate an integrated image. FIG. 12 shows an example of a configuration of the integrated image G according to the present embodiment. In the integrated image G, each boundary of the lobes of the lungs color-coded according to the range Dₙ of each coronal section Iₙ is superimposed and displayed on each frame of the dynamic image.

The controller 30 outputs the generated integrated image to the display part 33 to display the integrated image on the screen (step S10). Step S10 corresponds to an output step. The integrated image may be displayed as a moving image, may be displayed by arranging the frame images, or may be displayed by sequentially switching the frame images in accordance with the operation of the operation part 32. In this way, in the present embodiment, a series of processing of the image integration processing is executed.

As described above, according to the present embodiment, the third DRR image Ic in which the boundary between the lobes of the lung is visualized is combined with each frame of the dynamic image. Accordingly, for example, at the time of diagnosis of lung resection surgery, in addition to pleurodesis by a dynamic image, the degree of adhesion of the lobes of the lung (lobular failure) can also be confirmed on the same screen. As a result, since it is not necessary to individually confirm both the dynamic image by the dynamic imaging apparatus 1 and the CT image by the CT apparatus 2, it is possible to improve efficiency at the time of diagnosis by a user such as a physician. Note that in the above-described embodiment, the lobe division of the lung has been described as an example of the anatomical information, but the same effect can be achieved for anatomical information of other blood vessels, bronchus, or the like, and lesion information such as a nodule, a tumor, stenosis of a blood vessel, calcification, or an aortic aneurysm.

According to the present embodiment, when the second DRR image Ib is generated from the CT image, the boundaries of the lobes of the lungs in each coronal section Iₙ are visualized in different colors and shades depending on the distances Dₙ from the reference position. Thus, since the depth of each boundary of the segmented lobes of the lungs can be grasped in the dynamic image, the degree of adhesion of the segmented lobes of the lungs can be accurately estimated at the time of diagnosis.

According to the present embodiment, the amount of motion of the boundary BR1ₙ between the right upper lobe RU and the right middle lobe RM, the boundary BR2ₙ between the right middle lobe RM and the right lower lobe RL, and the boundary BLₙ between the left upper lobe LU and the left lower lobe LL due to breathing can be quantified including the amount of motion in the depth direction. The quantification includes, for example, numerical conversion. As a result, the degree of lobular failure can be predicted from the smoothness and size of the movement of the boundary of each lobe. In addition, it is possible to capture a change in the state of the lung by quantifying a difference in the movement of the boundary between the lobes in the past and the current examination.

In addition, it is said that the movement of the upper lung field tends to be small in the case of severe chronic obstructive pulmonary disorder. Conventionally, it can be confirmed that the movement of the upper lung field is small by analyzing a dynamic image. However, in the conventional analysis of dynamic images, it is only possible to understand the upper part of the entire lung field, and it is difficult to minutely grasp the lung field in units of lobes. According to the present embodiment, by digitizing the degree of movement between the lobes, it is possible to observe the symptom separately for each lobe, and to accurately analyze chronic obstructive lung disease.

### Other Display Examples of Third DRR Image Ic

An example in which the second DRR image Ib obtained by visualizing all the boundaries of the lobes of the lungs in the sixteen coronal sections Iₙ is superimposed on the first DRR image Ia of the CT image in the above-described third DRR image Ic has been described, but the present invention is not limited thereto.

### Other Display Example 1 of the Third DRR Image Ic

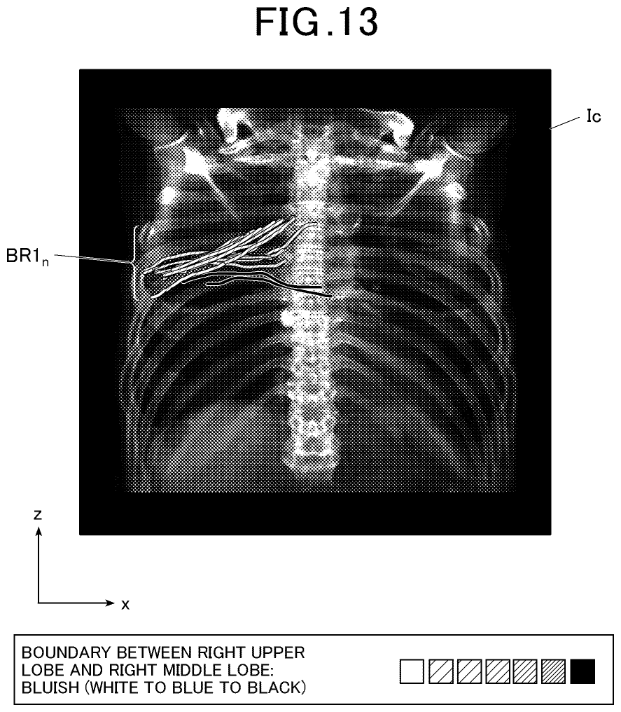

FIG. 13 shows another display example 1 of the third DRR image Ic in a case where only the boundary BR1ₙ between the right upper lobe RU and the right middle lobe RM is visualized. The controller 30 generates the second DRR image Ib in which the boundary BR1ₙ between the right upper lobe RU and the right middle lobe RM in the sixteen coronal sections Iₙ is visualized. Subsequently, the controller 30 generates the third DRR image Ic by superimposing the generated second DRR image Ib on the first DRR image Ia of the CT image. According to the other display example 1, only the boundary BR1ₙ between the right upper lobe RU and the right middle lobe RM is partially displayed, so that only the movement of the necessary boundary between the lobes to be observed can be observed.

### Another Display Example 2 of the Third DRR Image Ic

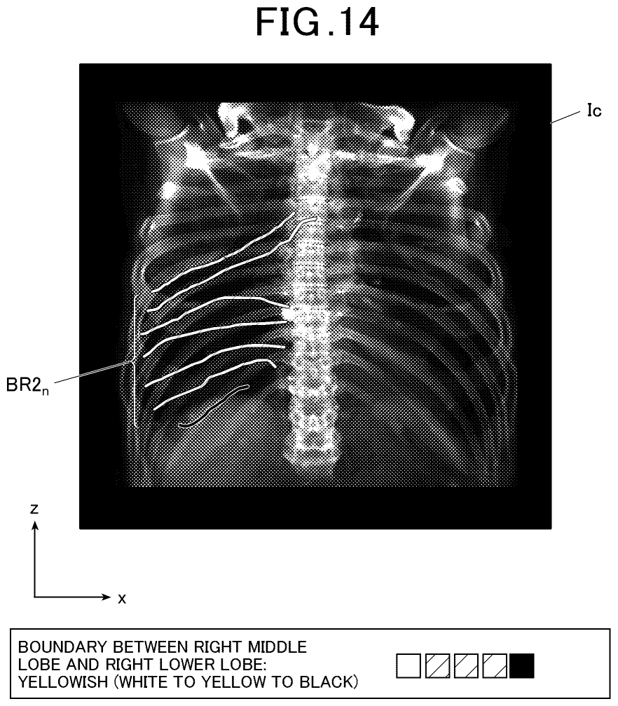

FIG. 14 shows another display example 2 of the third DRR image Ic in a case where only the boundary BR2ₙ between the right middle lobe RM and the right lower lobe RL is visualized. The controller 30 generates the second DRR image Ib in which the boundary BR2ₙ between the right middle lobe RM and the right lower lobe RL in the sixteen coronal sections Iₙ is visualized. Subsequently, the controller 30 generates the third DRR image Ic by superimposing the generated second DRR image Ib on the first DRR image Ia of the CT image. According to the other display example 2, since only the boundary BR2ₙ between the right middle lobe RM and the right lower lobe RL is partially displayed, only the movement of the boundary of the necessary lobes to be the observation target can be observed.

### Other Display Example 3 of the Third DRR Image Ic

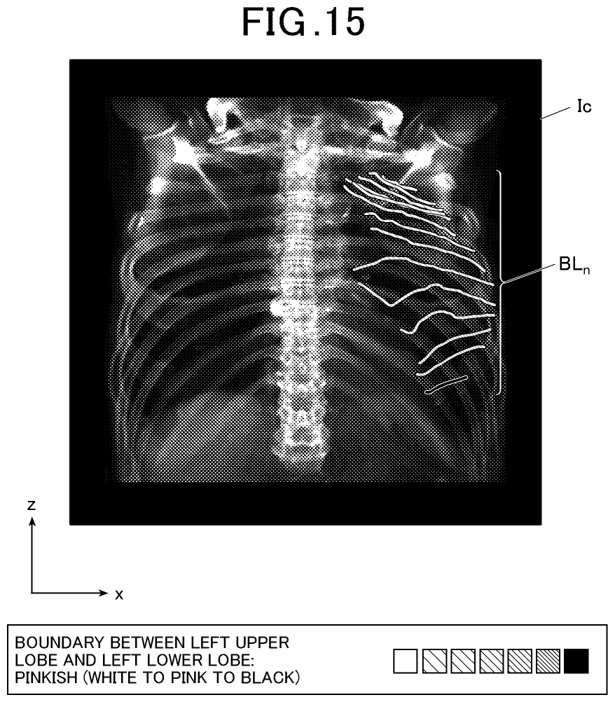

FIG. 15 shows another display example 3 of the third DRR image Ic when only the boundary BLₙ between the left upper lobe LU and the left lower lobe LL is visualized. The controller 30 generates the second DRR image Ib in which the boundary BLₙ between the left upper lobe LU and the left lower lobe LL in the sixteen coronal sections Iₙ is visualized. Subsequently, the controller 30 generates the third DRR image Ic by superimposing the generated second DRR image Ib on the first DRR image Ia of the CT image. According to other display example 3, only the boundary BLₙ between the left upper lobe LU and the left lower lobe LL is partially displayed, so that only the movement of the necessary boundary between the lobes to be observed can be observed.

### Another Display Example 4 of the Third DRR Image Ic

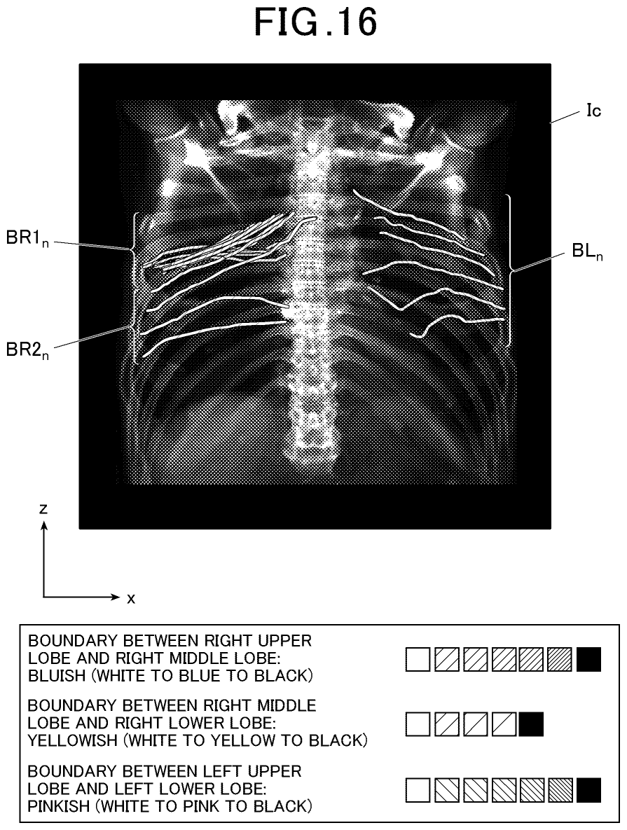

FIG. 16 shows another display example 4 of the third DRR image Ic in the case of visualizing the boundary BR1ₙ between the right upper lobe RU and the right middle lobe RM, the boundary BR2ₙ between the right middle lobe RM and the right lower lobe RL, and the boundary BLₙ between the left upper lobe LU and the left lower lobe LL in the middle six cross sections among the sixteen coronal sections Iₙ Hereinafter, a case in which, for example, the sixth to eleventh coronal sections I₆ to I₁₁ are used as the six intermediate cross sections will be described. The controller 30 generates the second DRR image Ib in which the boundary BR1ₙ between the right upper lobe RU and the right middle lobe RM, the boundary BR2ₙ between the right middle lobe RM and the right lower lobe RL, and the boundary BLₙ between the left upper lobe LU and the left lower lobe LL in the six middle cross sections are visualized. Subsequently, the controller 30 generates the third DRR image Ic by superimposing the generated second DRR image Ib on the first DRR image Ia of the CT image. According to the other display example 4, since only the boundaries of the respective lobes in the middle six cross sections of the sixteen coronal sections Iₙ are partially displayed, the movement of the boundaries of the respective lobes can be observed in more detail.

### Other Display Examples 5 of the Third DRR Image Ic

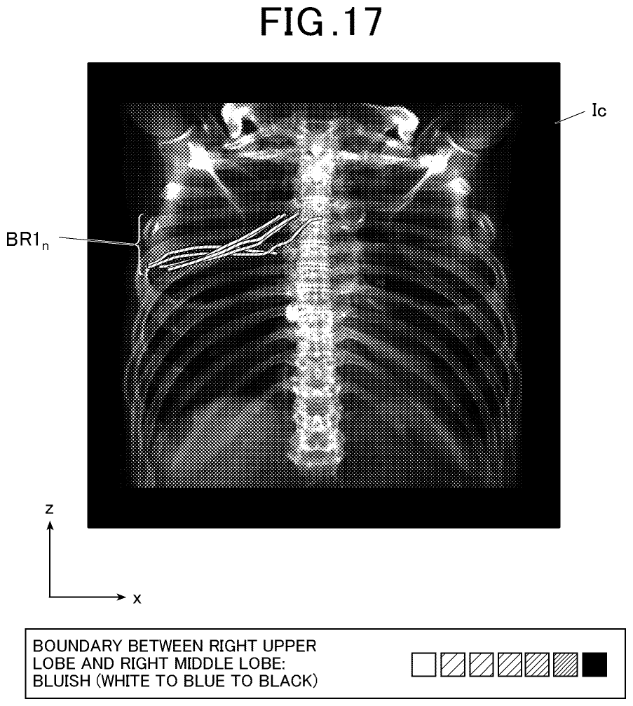

FIG. 17 shows another display example 5 of the third DRR image Ic in the case of visualizing only the boundary BR1ₙ between the right upper lobe RU and the right middle lobe RM in the middle six cross sections among the sixteen coronal sections Iₙ. The controller 30 generates the second DRR image Ib in which the boundary BR1ₙ between the right upper lobe RU and the right middle lobe RM in the six cross sections is visualized. Subsequently, the controller 30 generates the third DRR image Ic by superimposing the generated second DRR image Ib on the first DRR image Ia of the CT image. According to the other display example 5, since only the boundaries of the respective lobes in the middle six cross sections of the sixteen coronal sections Iₙ are partially displayed, the movement of the boundaries of the respective lobes can be observed in more detail.

### Other Display Example 6 of Third DRR Image Ic

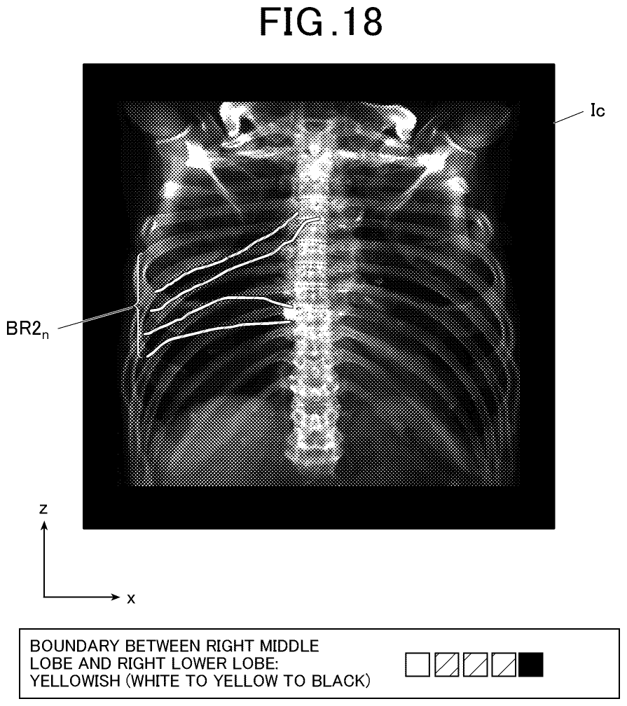

FIG. 18 shows another display example 6 of the third DRR image Ic in a case where only the boundary BR2ₙ between the right middle lobe RM and the right lower lobe RL in the middle six cross sections among the sixteen coronal sections Iₙ is visualized. The controller 30 generates the second DRR image Ib in which the boundary BR2ₙ between the right middle lobe RM and the right lower lobe RL in the middle six cross sections is visualized. Subsequently, the controller 30 generates the third DRR image Ic by superimposing the generated second DRR image Ib on the first DRR image Ia of the CT image. According to the other display example 6, since only the boundaries of the respective lobes in the middle six cross sections of the sixteen coronal sections Iₙ are partially displayed, the movement of the boundaries of the respective lobes can be observed in more detail.

### Other Display Examples 7 of the Third DRR Image Ic

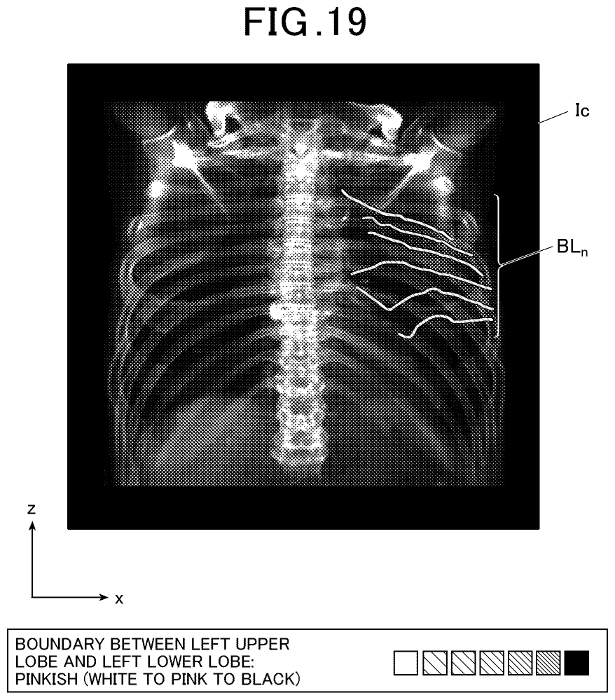

FIG. 19 shows another display example 7 of the third DRR image Ic in a case where only the boundary BLₙ between the left upper lobe LU and the left lower lobe LL in the middle six cross sections among the sixteen coronal sections Iₙ is visualized. The controller 30 generates the second DRR image Ib in which the boundary BLₙ between the left upper lobe LU and the left lower lobe LL in the middle six cross sections is visualized. Subsequently, the controller 30 generates the third DRR image Ic by superimposing the generated second DRR image Ib on the first DRR image Ia of the CT image. According to the other display example 7, since only the boundary of each segmented lobe in the middle six cross sections among the sixteen coronal sections Iₙ is partially displayed, the movement of the boundary of each segmented lobe can be observed in more detail.

Although the preferred embodiments of the present disclosure have been described in detail with reference to the accompanying drawings, the technical scope of the present disclosure is not limited to such examples. Furthermore, those to which various modification examples and improvements have been applied naturally belong to the technical scope of the present disclosure within the category of the technical idea described in the scope of the claims of those skilled in the art. Although embodiments of the present invention have been described and shown in detail, the disclosed embodiments are made for purposes of illustration and example only and not limitation. The scope of the present invention should be interpreted by terms of the appended claims.

According to an aspect of the present invention, since the dynamic image and the DRR image to which the depth information of the anatomical information or the lesion information is added are combined, it is possible to confirm the depth information such as the anatomical information which cannot be seen only by the dynamic imaging at the time of diagnosis.

What is claimed is:

1. An image processing apparatus comprising:
a hardware processor that:
acquires a dynamic image including a plurality of frame images by performing dynamic imaging on a target site of a subject by a radiation imaging apparatus;
acquires a functional information image including volume data including a plurality of voxels by imaging the target site by another modality different from the radiation imaging apparatus;
acquires anatomical information or lesion information regarding the target site of the functional information image;
generates a DRR image based on the acquired functional information image and the anatomical information or the lesion information that is acquired;
integrates a plurality of frames of the acquired dynamic image and the generated DRR image to obtain an integrated image; and
outputs the integrated image, wherein
the hardware processor adds, to the DRR image, depth information indicating a distance from a reference position of the anatomical information or the lesion information in the volume data.

2. The image processing apparatus according to claim 1, wherein
the anatomical information is a lobe of a lung, a blood vessel, or a bronchus.

3. The image processing apparatus according to claim 1, wherein
the lesion information is a nodule, a tumor, a stenosis of a blood vessel, calcification, or an aortic aneurysm.

4. The image processing apparatus according to claim 1, wherein
the hardware processor configures a plurality of coronal sections from the volume data, and two dimensionally visualizes the anatomical information or the lesion information for each of the plurality of coronal sections in the DRR image.

5. The image processing apparatus according to claim 4, wherein
the depth information is a distance between a reference coronal section serving as the reference position and the coronal section including the anatomical information or the lesion information.

6. The image processing apparatus according to claim 5, wherein
the hardware processor changes a display manner of the anatomical information or the lesion information on each of the coronal sections visualized in the DRR image, according to the distance of the anatomical information or the lesion information on each of the coronal sections.

7. The image processing apparatus according to claim 6, wherein
a range of a color is set in advance for each piece of the anatomical information, and
the hardware processor color-codes the anatomical information, or the lesion information based on the color and the distance.

8. The image processing apparatus according to claim 1, wherein
the hardware processor generates a first DRR image of the functional information image, generates a second DRR image of the anatomical information or the lesion information of the functional information image, and thereafter generates the DRR image by superimposing the second DRR image on the first DRR image.

9. An image processing method comprising:
first acquiring that is acquiring a dynamic image including a plurality of frame images by performing dynamic imaging on a target site of a subject by a radiation imaging apparatus;
second acquiring that is acquiring a functional information image including volume data including a plurality of voxels by imaging the target site by another modality different from the radiation imaging apparatus;
third acquiring that is acquiring anatomical information or lesion information regarding the target site of the functional information image;
generating that is generating a DRR image based on the acquired functional information image and the anatomical information or the lesion information that is acquired;
integrating that is integrating a plurality of frames of the acquired dynamic image and the generated DRR image to obtain an integrated image; and
outputting that is outputting the integrated image, wherein
in the generating, depth information indicating a distance from a reference position of the anatomical information or the lesion information in the volume data is added to the DRR image.

10. A non-transitory recording medium storing a computer-readable program causing a computer to execute:
first acquiring that is acquiring a dynamic image including a plurality of frame images by performing dynamic imaging on a target site of a subject by a radiation imaging apparatus;
second acquiring that is acquiring a functional information image including volume data including a plurality of voxels by imaging the target site by another modality different from the radiation imaging apparatus;
third acquiring that is acquiring anatomical information or lesion information regarding the target site of the functional information image;
generating that is generating a DRR image based on the acquired functional information image and the anatomical information or the lesion information that is acquired;
integrating that is integrating a plurality of frames of the acquired dynamic image and the generated DRR image to obtain an integrated image; and
outputting that is outputting the integrated image, wherein
in the generating, depth information indicating a distance from a reference position of the anatomical information or the lesion information in the volume data is added to the DRR image.
